(19) United States
(12) Patent Application Publication
(10) Pub. No.: US 2006/0208589 A1
(43) Pub. Date: Sep. 21, 2006

(54) Integrated magnetic/foil bearing and methods for supporting a shaft journal using the same

(76) Inventors: Gerald K. Foshage, Boxford, MA (US); Edward C. Lovelace, Arlington, MA (US)

Correspondence Address: WEINGARTEN, SCHURGIN, GAGNEBIN & LEBOVICI LLP, TEN POST OFFICE SQUARE, BOSTON, MA, 02109, US

(21) Appl. No.: 11/205,495

(22) Filed: Aug. 16, 2005

Related U.S. Application Data
(60) Provisional application No. 60/602,299, filed on Aug. 16, 2004.

(51) Int. Cl. H02K 5/16; H02K 7/08

(52) U.S. Cl. 310/90

(57) ABSTRACT

An integrated bearing system (10) for supporting a rotatable shaft journal (58). The system (10) comprises a foil bearing (40) in combination with a magnetic field generating device (50) that produces a magnetic bearing capability to the rotatable shaft journal (58). The foil bearing (40) is integrated into the magnetic field generating device (50), leaving an air gap between the shaft journal (58) and the foil bearing (10). Under normal operating conditions, the magnetic field generating device (50) and the foil bearing (10) each provide a portion of the support to the shaft journal (58).

### CROSS-REFERENCE TO RELATED APPLICATIONS

The present invention claims the right of priority of U.S. provisional patent application No. 60/602,299, which was filed on Aug. 16, 2004 and which is incorporated in its entirety herein by reference.

### ACKNOWLEDGEMENT OF FEDERALLY SPONSORED RESEARCH OR DEVELOPMENT

The U.S. Government has a paid-up license in this invention and the right, in limited circumstances, to require the patent owner to license others on reasonable terms as provided for by the terms of Contract Number FA8650-04-C-2493 awarded by the Department of the Air Force.

### BACKGROUND OF THE INVENTION

1. Field of the Invention

The present invention relates to devices for supporting a shaft journal and, more specifically, to an integrated bearing that, at lower speeds, is supported primarily by a magnetic bearing and at higher speeds is supported primarily by a foil bearing.

2. Background Art

The use of magnetic bearings in conjunction with foil bearings to support a rotating shaft journal, e.g., a turbine shaft, is well known to the art. Typically, however, in such combinations, each bearing type is capable of supporting the rotating shaft without the assistance of the other bearing. Hence, the combination merely provides a primary support bearing and a back-up support bearing. Indeed, as described in greater detail below, the current state-of-the-art merely uses the advantages of the one bearing type to counter the disadvantages of the other bearing type and vice versa.

For example, referring to FIG. 1, foil bearings, typically, consist of a plurality of foil supports that are structured and arranged about a shaft journal. Foil supports, typically, comprise a thin, flexible metallic foil. As the shaft rotation accelerates, a film of air between the shaft journal and at-rest contact points on the foil is created, producing a hydrodynamic force on the rotating shaft. As a result, the rotating shaft begins to move outward from its axis of rotation, i.e., precess. Consequently, the opposing hydrodynamic force and, sometimes, the foil support itself resist further outward movement, keeping the shaft centered on or substantially centered on its axis of rotation. Because foil bearings rely on the rotating shaft to create a film of air, foil bearings are more effective at higher speeds.

The disadvantages or shortcomings of foil bearings include system instability and excessive contact between the shaft and the foil supports during starting, stopping, and peak load conditions. System instability, which can produce undesirable vibrations, can result from a shaft that is not perfectly cylindrical. Excessive contact can seriously damage the structural integrity of the bearing. Furthermore, because foil bearings rely on a thin layer of compressed air to support the shaft journal, necessarily, foil bearings are more effective at higher rotating speeds where the air pressure is greater.

Magnetic bearings, on the other hand, utilize a plurality of opposing permanent magnets and/or a plurality of opposing electromagnets to provide separation between rotating and non-rotating parts. Current supplied to the electromagnets induces a magnetic flux field that levitates the shaft between the opposing magnetic fields. When multiple magnetic bearings are employed, the current can be controlled to vary the intensities of the magnetic fields. Such variance enables the magnetic bearings to control and to adjust the position of the shaft journal to center the shaft journal along its axis of rotation. Magnetic bearings also are more effective at lower speeds because eddy currents at high speed produce a roll-off in force capacity given a fixed available power supply.

Disadvantages and shortcomings associated with magnetic bearings, however, include total loss or partial diminution of field strength, e.g., due to a power loss or to the age of the permanent magnets, respectively. In the case of a total loss of power, failure would be catastrophic. An often proposed solution to prevent a complete failure resulting from a total loss of power involves providing an uninterruptible power supply system. However, in most cases this is impractical because it would be very expensive. A solution to a diminution of field strength would be periodic replacement of the permanent magnets. However, this, too, would be expensive and, further, would require shutting down the system periodically during the replacement operation.

U.S. Pat. No. 5,519,274 to Scharrer discloses a magnetically-active foil bearing 20, which is depicted in FIG. 1. According to the Scharrer disclosure, a magnetic bearing provides a primary bearing means with a foil bearing used as a back-up bearing in the event of a total power failure that would interrupt current flow to the electromagnets. The Scharrer foil bearing consists of a plurality of arcuately-shaped foil supports 28, whose convex portion 26 is in proximity of an outer housing 22. The foil supports 28 are structured and arranged between a plurality of tabs 24, which extend radially inward from the outer housing 22.

Magnetic field generating members (not shown), e.g., electromagnets or permanent magnets, are associated with each foil support 28. The magnetic field generating members are connected to a power source and, when energized, induce a magnetic field in the shaft receiving space 40 where the shaft journal S is disposed. Shaft positioning sensors and a current control means (not shown) are used to vary the current—and, hence, the field strength—being delivered to each of the magnetic field generating members. In this way, the position of the shaft can be controlled by varying the current flow to each of the magnetic field generating members.

The shortcomings of the Scharrer magnetically active foil bearing 20 include the convex leaf foil 36 itself, which offers a very small contact surface area with the rotor shaft S. Because the contact surface area is small, the shaft load pressures on the foil 36 at that point can be very high. Similarly, the Scharrer foils 36 are arranged in the housing 22 non-uniformly, which can further reduce the load pressure capability of the foil bearing 28. Finally, according to Scharrer the foil bearing 28 is merely used as a back-up in the event that, power is lost and the primary, magnetic bearing cannot levitate the shaft S. In short, there is no load sharing between the magnetic bearing and the foil bearing 38.

U.S. Pat. No. 6,135,640 to Nadjani discloses another hybrid foil/magnet bearing. According to the Nadjani patent, a pair of split rings disposed in circumferential grooves in the rotor control the proximity of the foils to the shaft journal. The rings are connected to a controllable power source, which, depending on its state, can open and close the rings. For example, when power is ON, the rings are open and exert pressure against the foil segments, forcing the foil segments away from the shaft. When power is OFF, the rings are closed and the foil segments exert pressure against the rotating shaft.

Accordingly, during the power ON state, the rings force the foil segments away from the shaft and magnetic bearings levitate and support the shaft. In contrast, during the power OFF state, there is no current flowing to the magnetic bearing, however, the rings are closed, which allows the foil segments to press against the shaft and the foil bearings support the shaft. Here again, there is no load sharing between the magnetic bearings and the foil bearings.

U.S. Pat. No. 6,353,273 to Heshmat, et al. discloses still another hybrid foil/magnetic bearing system. According to Heshmat, magnetic bearings and the foil bearings are structured and arranged coaxially about the shaft journal, but they are disposed mechanically in series along the shaft, i.e., side-by-side and not concentrically. The problem with such a configuration is that a side-by-side arrangement causes the device to be too large and too heavy because each of the side-by-side structures generally requires its own, bulky support structure. Moreover, the net force density, which can be defined by the equation:

$$\frac{{F}_{MAG} + {F}_{FOIL}}{{A}_{MAG} + {A}_{FOIL} + {A}_{GAP}}$$

where A is surface area, F is force, MAG refers to the magnetic bearing, FOIL refers to the foil bearing and GAP refers to the area between the two bearings, is potentially not well optimized. Although, the formula suggests load sharing between the magnetic bearings and the foil bearings, structuring the bearings in series unnecessarily reduces the force density. Force density is particularly important for aerospace gas turbine engine applications because if the hybrid bearing is too large there will not be available space within the engine envelope to accommodate the bearing without severely impacting turbine efficiency and flight system weight.

Technological advances in foil design, e.g., third generation (or “3G”) foil bearings, enhance performance of the foil bearing by providing greater hydrodynamic force capacity than previous generation bearings. First generation foil bearings, comprising foils with uniformly spaced foil bumps, are less effective at limiting air leakage, reducing the hydrodynamic force capacity. Likewise, second generation foil bearings, which comprise non-uniformly spaced foil bumps, are more effective at limiting air leakage in the circumferential direction but not the axial direction. As can be seen in FIG. 3, 3G foil bearings offer a significant improvement in load capacity over first generation bearings.

Therefore, it would be desirable to provide an integrated hybrid magnetic/airflow bearing in which load sharing between the two bearing types is possible. Designing an integrated hybrid magnetic/airflow bearing for load sharing can reduce the axial length of the bearing and, therefore, make the system smaller and lighter. It would also be desirable to provide an integrated hybrid magnetic/foil bearing that provides a maximum load pressure capability.

### BRIEF SUMMARY OF THE INVENTION

In a preferred embodiment, the present invention provides an integrated bearing system for supporting a rotatable shaft journal. Preferably, the system comprising a foil bearing; and a magnetic field generating device that produces a magnetic bearing capability to the rotatable haft journal. More preferably, the foil bearing is integrated into the magnetic field generating device, leaving an air gap between the shaft journal and the foil bearing and, most preferably, under normal operating conditions, the magnetic field generating device and the foil bearing each provide a portion of the support to the shaft journal.

In one aspect of the preferred embodiment, the foil bearing includes a corrugated bumped foil portion, having a pitch between a plurality of bump crests and bump troughs, that is disposed on an underside of an outer foil portion. Preferably, the pitch between the plurality of bump crests and bump troughs is uniform or non-uniform.

In another aspect of the preferred embodiment, the system further comprises an outer housing; and a plurality of foil bearing supports that are structured and arranged about the outer housing and oriented radially inwardly therefrom for supporting the foil bearing. Optionally, one or more of the plurality of foil bearing supports is used as a pole for the magnetic field generating device by wrapping a plurality of coil windings around said one or more foil bearing supports. Alternatively, the outer housing can be used as a pole for the magnetic field generating device by wrapping a plurality of coil windings around said outer housing between adjacent foil bearing supports.

In yet another aspect of the preferred embodiment, the magnetic field generating device provides a greater portion of support to the shaft journal when said shaft journal is not rotating or is operating at lower rotating speeds. Preferably, the magnetic field generating device includes a permanent magnet or an electromagnet. Furthermore, the foil bearing provides a greater portion of support to the shaft journal when said shaft journal is operating at higher rotating speeds. Preferably, the foil bearing is a third generation-type foil bearing. More preferably, the foil bearing is made of a non-ferromagnetic material with high electrical resistivity.

In still another aspect of the present invention, the shaft journal is made of a laminated, ferromagnetic material that has been annealed. Preferably, the shaft journal is coated with a thin layer of a non-conductive, anti-corrosive, low friction, high hardness, anti-galling finish. More preferably, the thin layer is applied by vacuum plasma deposition, electroplating, high-velocity impact (sputtering) or flame spray techniques.

In a further aspect of the preferred embodiment, the foil bearing and the magnetic field generating device are structured and arranged concentrically and coaxially along the length of the shaft journal. Moreover, the foil bearing and the magnetic field generating device are structured and arranged with unequal axial lengths along the length of the shaft journal so that the axial length of said foil bearing is longer or shorter than the axial length of said magnetic field generating device.

In a second embodiment, the present invention provides a method of supporting a rotatable shaft journal, the method comprising the steps of:

providing a magnetic field generating device that provides a magnetic bearing capability;

integrating a foil bearing with the magnetic field generating device, wherein the foil bearing is integrated into the magnetic field generating device, leaving an air gap between the shaft journal and said foil bearing; and

structuring and arranging the magnetic field generating device and the foil bearing so that each provides a portion of the support to the shaft journal concurrently under normal operating conditions.

In a third embodiment, the present invention provides an integrated bearing system for supporting a shaft journal. Preferably, the system comprises a foil bearing; and a magnetic field generating device. Preferably, the foil bearing is integrated into the magnetic field generating device, leaving an air gap between the shaft journal and an outermost surface of the foil bearing. More preferably, the magnetic field generating device and the foil bearing are structured and arranged to provide high force densities to support to the shaft journal.

In one aspect of the third embodiment, the foil bearing includes a corrugated bumped foil portion, having a pitch between a plurality of bump crests and bump troughs, that is disposed on an underside of an outer foil portion.

In another aspect of the third embodiment, the system further comprises an outer housing; and a plurality of foil bearing supports that are structured and arranged about the outer housing and oriented radially inwardly therefrom for supporting the foil bearing. Optionally, one or more of the plurality of foil bearing supports is used as a pole for the magnetic field generating device by wrapping a plurality of coil windings around said one or more foil bearing supports. Alternatively, the outer housing can be used as a pole for the magnetic field generating device by wrapping a plurality of coil windings around said outer housing between adjacent foil bearing supports.

In yet another aspect of the third embodiment, the magnetic field generating device provides a greater portion of support to the shaft journal when said shaft journal is not rotating or is operating at lower rotating speeds. Preferably, the magnetic field generating device includes a permanent magnet or an electromagnet. Furthermore, the foil bearing provides a greater portion of support to the shaft journal when said shaft journal is operating at higher rotating speeds. Preferably, the foil bearing is a third generation-type foil bearing. More preferably, the foil bearing is made of a non-ferromagnetic material with high electrical resistivity.

In a further aspect of the third embodiment, the foil bearing and the magnetic field generating device are structured and arranged concentrically and coaxially along the length of the shaft journal. Moreover, the foil bearing and the magnetic field generating device are structured and arranged with unequal axial lengths along the length of the shaft journal so that the axial length of said foil bearing is longer or shorter than the axial length of said magnetic field generating device.

In yet another embodiment, the present invention provides a method of supporting a rotatable shaft journal, the method comprising the steps of:

providing a magnetic field generating device that provides a magnetic bearing capability;

integrating a foil bearing with the magnetic field generating device, wherein the foil bearing is integrated into the magnetic field generating device coaxially and concentrically about an axis or rotation of the shaft journal, leaving an air gap between the shaft journal and an outermost surface of the foil bearing; and

structuring and arranging the magnetic field generating device and the foil bearing to provide high force densities concurrently to support said shaft journal.

### BRIEF DESCRIPTION OF THE DRAWINGS

The invention will be better understood by reference to the following more detailed description and accompanying drawings where like reference numbers refer to like parts:

FIG. 1 is an illustrative embodiment of a magnetically active foil bearing known in the prior art;

FIG. 2 is a graph showing the relationship between speed and load capacity for first and third generation foil bearings;

FIG. 3 is a diagrammatic of an isometric view of a third generation foil bearing comprising a plurality of rings in accordance with a preferred embodiment of the present invention;

FIG. 4 is a diagrammatic of a sectional view of a foil bearing in accordance with a preferred embodiment of the present invention;

FIG. 5A is a diagrammatic cross section view of a radial magnetic bearing pole embodiment in accordance with the present invention;

FIG. 5B is diagrammatic cross section views of a combined axial and radial magnetic bearing pole embodiment with axial coils in accordance with the present invention;

FIG. 5C is diagrammatic cross section views of a combined axial and radial magnetic bearing pole embodiment with radial coils in accordance with the present invention; and

FIGS. 6A through 6E provide alternative radial embodiments of supporting schemes for supporting the hybrid magnetic/foil bearing device in accordance with the present invention.

### DETAILED DESCRIPTION OF THE INVENTION AND PREFERRED EMBODIMENTS THEREOF

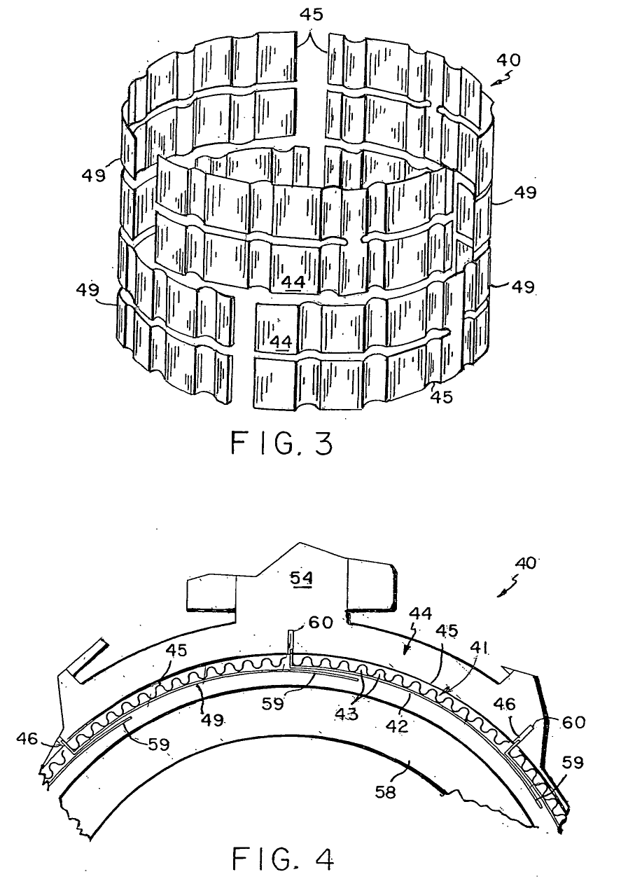

Referring to FIGS. 3 and 4, a preferred embodiment of a third generation (“3G”), pneumatic foil bearing 40 in accordance with the current state-of-the-art that will be described. Three-G foil bearings 40 enhance bearing performance by providing air support in axial, radial, and circumferential directions.

In a preferred embodiment, the 3G foil bearing 40 comprises a plurality of foil bearing segments 49 that are structured and arranged to fully circumscribe the entire periphery of the shaft journal 58. Preferably, each foil bearing segment 49 comprises a flexible, bumped foil portion 44 that is fixedly attached to an underside of an outer foil portion 42. More preferably, the bumped foil portion 44 has a sinusoidal or substantially sinusoidal configuration with variable pitch lengths between the crests or troughs of the bump sinusoids 45. Most preferably, each of the outer foil portions 42 is structured and arranged to include an anchor portion 46, which can be removably secured in an anchor slot 60, at a first end and an overlap portion 59 at a second end. In one aspect of the foil bearing segment 49, each overlap section 59 extends beyond the anchor portion 46 of the adjacent foil bearing segment 49.

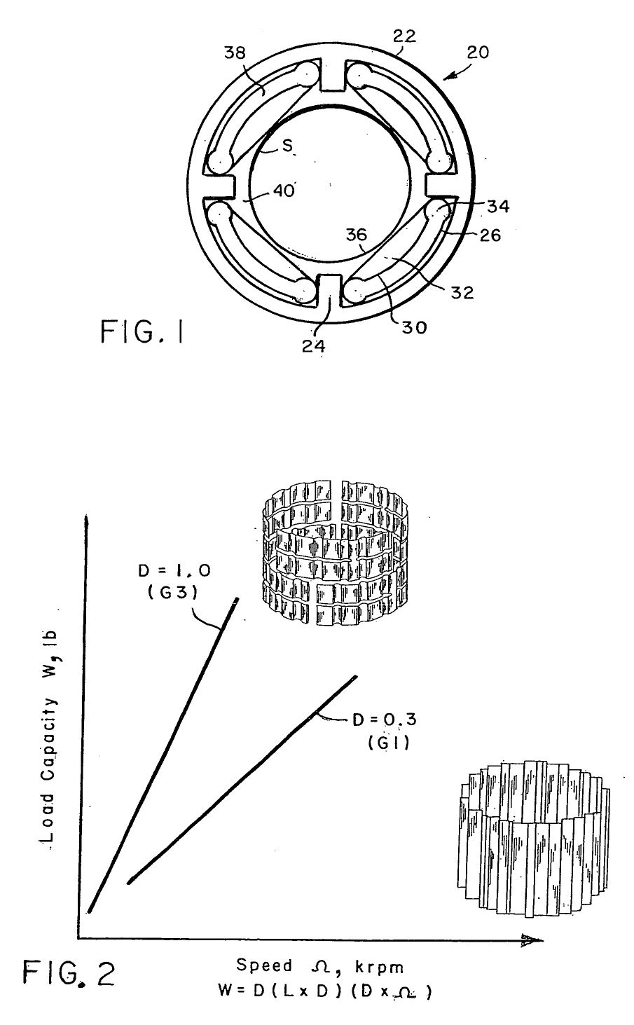

Foil bearings 40 perform differently than standard foil bearings. For example, foil bearings 40 are structured and arranged to provide openings 43, e.g., between adjacent crests or troughs of the bump sinusoids 45, for entrapping air. As a result, during high-speed operation, air trapped in the openings 43 is further compressed and the compressed air supports and regulates the position of the shaft journal 58. As shown in FIG. 2, this allows the 3G foil bearing 40 to achieve a higher pressure and a higher force density as the rotating speed of the journal 58 increases.

Since 3G foil bearings 40 provide higher force densities at higher speeds, the inventors have found that, it makes sense to take advantage of this phenomenon and to use these higher densities to share supporting the weight of the shaft journal 58 with magnetic bearings 55. Indeed, according to the present invention, the magnetic bearing 55 provides proportionally greater—but not exclusive—shaft journal 58 support at relatively lower rotating speeds at which passive foil bearings 40 operate less effectively. At relatively higher speeds, at which performance of magnetic bearings 55 deteriorates and performance of the foil bearings 40 improves, the foil bearings 40 provide proportionally greater—but not exclusive support—to the shaft journal 58.

Accordingly, the purpose of the embodied 3G foil bearings 40 is to load share support of a rotary shaft journal 58, e.g., a turbine shaft journal, with the magnetic bearing 55. The practical effect of a preferred concentric and coaxial arrangement minimizes the support area necessary and, therefore, minimizes the weight of the hybrid, integrated magnetic/foil bearing 50. Although the disclosure is written describing a 3G foil, the use of first and/or second generation foil bearings is totally within the scope and spirit of the this disclosure.

As shown in FIG. 3, in a preferred embodiment, the foil bearing 40 comprises one or more axially-split foil bearing segments 49. Currently, design estimates of foil bearings 40 are based on one (1) pound of load, i.e., the shaft journal 58, for every inch of bearing diameter and about 1,000-shaft revolutions per minute (rpm) for every square inch of surface area. Therefore, foil bearing segments 49 can be fabricated as a relatively wide, single piece or, alternatively, as multiple, smaller-width foil bearing segments 49. Either alternative can perform equally as well as long as they provide the same surface area and/or bearing diameter.

In a preferred embodiment, when the foil bearing 40 comprises multiple foil bearing segments 49, the foil bearing segments can be abutted against each other in an axial direction. It is not necessary to align the bump sinusoids 45 in any specific pattern. Indeed, a random pattern of bump sinusoids 45 is preferred. The invention, however, can be practiced even if the bump sinusoids 45 were perfectly aligned axially along the length of the shaft journal 58.

The composition of the foil bearing 40 should be of a non-ferromagnetic material that has a high electrical resistivity so that the foil bearing 40 does not interfere with the magnetic flux field. In a particular embodiment, the foil can be made of an annealed metal alloy, e.g., Inconel®-X-750, that is aged on a mandrel at 750 degrees Centigrade for at least 20 hours and, subsequently, heat treated.

In an exemplary embodiment, the outer foil portion 42 consists of a piece of annealed metal alloy, e.g., Inconel® X-750, that is about 0.004 inches (4 mils) thick. More preferably, the bumped foil portion 44 consists of a piece of annealed metal alloy, e.g., Inconel® X-750, about 0.004 inches (4 mils) thick that has been machined to provide bump sinusoids 45 that are about 0.020 inches (20 mils) in height. The distance between bump sinusoids 45, i.e., the pitch, can be variable. However, the pitch should be no greater than about 0.020 inches (20 mils). As mentioned previously, the pitch between bump sinusoids 45 provides an air gap 43. The outer foil portions 42 and bumped foil portion 44 can be attached by any means known to the art, e.g., welding, adhesives, and the like.

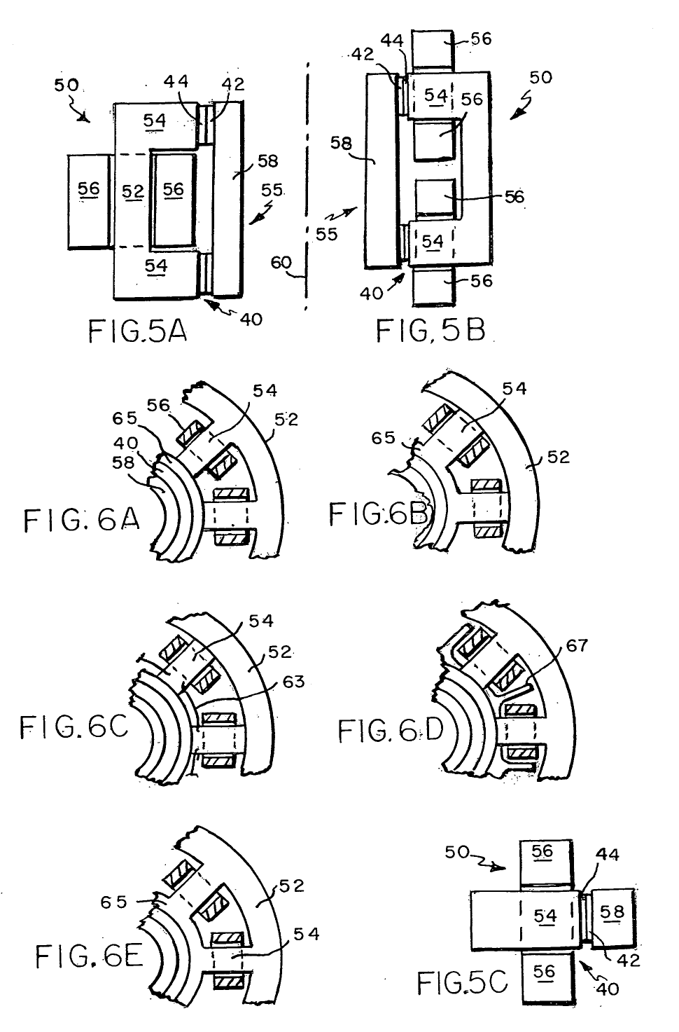

Having described a preferred embodiment of a 3G foil bearing 40, we will now describe a preferred embodiment of an integrated magnetic/foil bearing 50 incorporating such a device. Referring to FIGS. 5A-5C, preferably, the foil bearing 40 and the magnetic bearing 55 are structured and arranged co-axially and concentrically about the axis of rotation 60 of the shaft journal 56. More preferably, the foil bearing 40 and the magnetic bearing 55 are structured and arranged as an integrated unit, which is to say that, the foil bearing 40 is structured and arranged on a portion of the magnetic bearing 55, e.g., one or more foil bearing support 54, between the magnetic bearing 55 and the gap that is formed between the magnetic bearing 55 and the shaft journal 58.

This arrangement minimizes bearing support requirements. And, moreover, maximizes the force density of the integrated bearing 50. As a result, the force density of this arrangement is given by the following equation:

$$\frac{{F}_{MAG} + {F}_{FOIL}}{{A}_{MAG}}$$

where A is surface area, F is force, MAG refers to the magnetic bearing and FOIL refers to the foil bearing. It is intuitively obvious to the casual observer that, the force density of the integrated bearing of the present invention is much greater than that of Heshmat, et al. because the surface area of the gap (A_{GAP}) and the surface area of a separate magnetic bearing (A_{MAG}) (or a separate foil bearing (A_{FOIL})) have been eliminated from the denominator. It is recognized, though, that, there can be a minor penalty in the individual load capacity of each force source, but that the net force density is overall improved.

Using a weight-based instead of a surface area-based definition of force density, the same arguments and conclusions are reached. The force per unit mass of an optimized concentric hybrid magnetic/foil bearing will be greater than that of the side-by-side hybrid bearing.

In a preferred embodiment, the integrated magnetic/foil bearing 50 is structured and arranged so that the magnetic bearing 55 and the foil bearing 40 load share, which is to say that, under normal operating conditions, each supports the shaft journal 56 concurrently. Non-normal or abnormal operating conditions are defined as those conditions when one of the bearings is incapable of providing any support, e.g., a total power loss to the magnetic bearing 55.

Because foil bearing force increases approximately linearly with speed and the magnetic bearing force is substantially constant with respect to speed, the magnetic bearing 55 can be sized for the net force required at lower speeds (minus the foil bearing force capacity at lower speed) and the foil bearing 40 can be sized for the net force required at higher speeds (minus the magnetic bearing force capacity at higher speed). Moreover, the magnetic bearing 55 can be designed to provide greater support when the system is at or near the foil bearing resonant frequency to smooth the transition through that frequency range.

Referring to FIGS. 5A-5C, in a preferred embodiment, the integrated magnetic/foil bearing 50 comprises an outer housing 52, a plurality of foil bearing supports 54, a magnetic field generating device 56, e.g., an electromagnet or permanent magnet, and a foil bearing 40, which has been described above.

Preferably, the outer housing 52, which can be a stator, is a thin cylinder made of a magnetic material. More preferably, the outer housing 52 is made of steel, stainless steel, low carbon steel, soft, magnetic iron, or any relatively soft, magnetic metal and/or alloy that furthers the conduction of the magnetic flux field generated by the magnetic field generating device 56. Other metals, alloys, and ceramic material of a type that is known to the art that enable a high density magnetic flux field can be used without violating the scope and spirit of this disclosure. A plurality of foil bearing supports 54 extends radially inward from the outer housing 52.

The foil bearing supports 54 have a dual purpose. First, as their name suggests, they provide structural support and a controlled compliance to the foil bearings 40. Second, one or more foil bearing supports 54 can be used as a pole(s) about which a multiplicity of coil windings can be wound to provide a magnetic field generating device 56.

FIG. 5B, which provides an embodiment for radial coil flux for a combined axial and radial magnetic bearing pole, illustrates a magnetic filed generating device 56 that uses the foil bearing supports 54 as a pole. Alternatively, FIG. 5A provides an embodiment of axial coil flux for a combined axial and radial magnetic bearing pole in which a magnetic filed generating device 56 uses the outer housing 52 as a pole. FIG. 5C provides an embodiment for a radial magnetic bearing pole.

To induce a magnetic field for positioning the shaft journal 58, the coils or windings of the magnetic field generating device 56 can be connected to a power source (not shown) and directly or indirectly to a control system (not shown) in ways that are well known to those skilled in the art. The controller controls, modifies, and adjusts the magnitude of the flow of current through any particular set of coils. Because the amount of current flowing through any discrete set of coil windings determines the magnitude of the magnetic flux field generated at that location, the control system can levitate, support, and center the shaft journal 58 as necessary. To facilitate centering the shaft journal 58, a plurality of sensors (not shown) can be disposed near the shaft journal to provide shaft-positioning data to the control system.

Referring to FIGS. 6A to 6E, alternative embodiments of hybrid, integrated magnetic/foil bearings 50 are provided. In FIG. 6A, a concentric and coaxial ring 65 supports the foil bearing 40, which, in turn, is supported by the foil bearing supports 54 rather than the foil bearing supports 54 supporting the foil bearing 40 directly. In FIG. 6B, the foil bearing supports 54 is formed with the concentric and coaxial ring 65 rather than with the outer housing 62. In FIG. 6C, there is no coaxial ring 65 and the foil bearing supports 54 are not part formed with the outer housing 52. Accordingly, anchor supports 63 are provided between adjacent foil bearing supports 54 for greater strength at higher speeds. In FIG. 6D, the foil bearing supports 54 are used exclusively as poles for the magnetic field generating device 56 and supporting bridges 67 are provided between adjacent foil bearing supports 54 to support the foil bearing 40. Finally, in FIG. 6E, the outer housing 52, foil bearing supports 54, and coaxial ring 65 are formed as a single unit.

Although preferred embodiments of the invention have been described using specific terms, such descriptions are for illustrative purposes only, and it is to be understood that changes and variations may be made without departing from the spirit or scope of the following claims.

For example, although, the disclosure has described the integrated magnetic/foil bearing with an electromagnet as a magnetic field generating means, the invention is equally as applicable using, instead, a permanent magnet.

Also, although a 3G foil bearing has been described, first generation and second generation foil bearings also can be used but with less dramatic results.

Furthermore, although the shaft journal has been described herein as being surrounded by and rotating inside coaxial and concentric foil and magnetic bearings, that is not to say that the shaft journal or rotor cannot be hollow with the foil bearing and magnetic bearing being disposed inside of the shaft journal or rotor.

Moreover, the shaft journal of the present invention can be made of a laminated, ferromagnetic material that has been annealed. Preferably, the shaft journal can be further coated with a thin layer of one or more of a non-conductive finish, an anti-corrosive finish, a low friction finish, a high hardness finish, and an anti-galling finish. More specifically, the thin layers can be applied by vacuum plasma deposition, electroplating, high-velocity impact (sputtering) or flame spray techniques.

Additionally, although the preferred embodiment of the present invention has been described assuming that the axial lengths of the foil bearing and the magnetic bearings along the length of the shaft journal are equal or substantially equal, that is not to say that either could be slightly longer or slightly shorter than the other without affecting the performance of the hybrid, integrated bearing system.

What is claimed is:

1. An integrated bearing system for supporting a rotatable shaft journal, the system comprising:
a foil bearing; and
a magnetic field generating device that produces a magnetic bearing capability to the rotatable haft journal,
wherein the foil bearing is integrated into the magnetic field generating device, leaving an air gap between the shaft journal and the foil bearing; and
wherein under normal operating conditions, the magnetic field generating device and the foil bearing each provide a portion of the support to the shaft journal.

2. The system as provided in claim 1, wherein the foil bearing includes a corrugated bumped foil portion, having a pitch between a plurality of bump crests and bump troughs, that is disposed on an underside of an outer foil portion.

3. The system as recited in claim 2, wherein the pitch between the plurality of bump crests and bump troughs is uniform.

4. The system as recited in claim 2, wherein the pitch between the plurality of bump crests and bump troughs is non-uniform.

5. The system as recited in claim 1, wherein the system further comprises:
an outer housing; and
a plurality of foil bearing supports that are structured and arranged about the outer housing and oriented radially inwardly therefrom for supporting the foil bearing.

6. The system as recited in claim 5, wherein one or more of the plurality of foil bearing supports is used as a pole for the magnetic field generating device by wrapping a plurality of coil windings around said one or more foil bearing supports.

7. The system as recited in claim 5, wherein the outer housing can be used as a pole for the magnetic field generating device by wrapping a plurality of coil windings around said outer housing between adjacent foil bearing supports.

8. The system as recited in claim 1, wherein the foil bearing is a third generation-type foil bearing.

9. The system as recited in claim 1, wherein the foil bearing is made of a non-ferromagnetic material with high electrical resistivity.

10. The system as recited in claim 1, wherein the magnetic field generating device provides a greater portion of support to the shaft journal when said shaft journal is not rotating or is operating at lower rotating speeds.

11. The system as recited in claim 1, wherein the foil bearing provides a greater portion of support to the shaft journal when said shaft journal is operating at higher rotating speeds.

12. The system as recited in claim 1, wherein the foil bearing comprises one or more circumferentially-split rings that provide a desirable surface area.

13. The system as recited in claim 1, wherein the shaft journal is made of a laminated, ferromagnetic material that has been annealed.

14. The system as recited in claim 13, wherein the shaft journal is coated with a thin layer of a non-conductive, anti-corrosive, low friction, high hardness, anti-galling finish.

15. The system as recited in claim 14, wherein the thin layer is applied by vacuum plasma deposition, electroplating, high-velocity impact (sputtering) or flame spray techniques.

16. The system as recited in claim 1, wherein the magnetic field generating device includes a permanent magnet or an electromagnet.

17. The system as recited in claim 1, wherein the foil bearing and the magnetic field generating device are structured and arranged concentrically and coaxially along the length of the shaft journal.

18. The system as recited in claim 17, wherein the foil bearing and the magnetic field generating device are structured and arranged with unequal axial lengths along the length of the shaft journal so that the axial length of said foil bearing is longer or shorter than the axial length of said magnetic field generating device.

19. A method of supporting a rotatable shaft journal, the method comprising the steps of:
providing a magnetic field generating device that provides a magnetic bearing capability;
integrating a foil bearing with the magnetic field generating device, wherein the foil bearing is integrated into the magnetic field generating device, leaving an air gap between the shaft journal and said foil bearing; and
structuring and arranging the magnetic field generating device and the foil bearing so that each provides a portion of the support to the shaft journal concurrently under normal operating conditions.

20. An integrated bearing system for supporting a shaft journal, the system comprising:
a foil bearing; and
a magnetic field generating device,
wherein the foil bearing is integrated into the magnetic field generating device, leaving an air gap between the shaft journal and the foil bearing; and
wherein the magnetic field generating device and the foil bearing are structured and arranged to provide high force densities concurrently to support to the shaft journal.

21. The system as provided in claim 20, wherein the foil bearing includes a corrugated bumped foil portion, having a pitch between a plurality of bump crests and bump troughs, that is disposed on an underside of an outer foil portion.

22. The system as recited in claim 20, wherein the system further comprises:
an outer housing; and
a plurality of foil bearing supports that are structured and arranged about the outer housing and oriented radially inwardly therefrom for supporting the foil bearing.

23. The system as recited in claim 22, wherein one or more of the plurality of foil bearing supports is used as a pole for the magnetic field generating device by wrapping a plurality of coil windings around said one or more foil bearing supports.

24. The system as recited in claim 22, wherein the outer housing can be used as a pole for the magnetic field generating device by wrapping a plurality of coil windings around said outer housing between adjacent foil bearing supports.

25. The system as recited in claim 20, wherein the foil bearing is a third generation-type foil bearing.

26. The system as recited in claim 20, wherein the foil bearing is made of a non-ferromagnetic material with high electrical resistivity.

27. The system as recited in claim 20, wherein the magnetic field generating device provides a greater portion of support to the shaft journal when said shaft journal is not rotating or is operating at lower rotating speeds.

28. The system as recited in claim 20, wherein the foil bearing provides a greater portion of support to the shaft journal when said shaft journal is operating at higher rotating speeds.

29. The system as recited in claim 20, wherein the foil bearing comprises one or more circumferentially-split rings that provide a desirable surface area.

30. The system as recited in claim 20, wherein the magnetic field generating device includes a permanent magnet or an electromagnet.

31. The system as recited in claim 20, wherein the foil bearing and the magnetic field generating device are structured and arranged concentrically and coaxially along the length of the shaft journal.

32. The system as recited in claim 20, wherein the foil bearing and the magnetic field generating device are structured and arranged with unequal axial lengths along the length of the shaft journal so that the axial length of said foil bearing is longer or shorter than the axial length of said magnetic field generating device.

33. A method of supporting a rotatable shaft journal, the method comprising the steps of:
providing a magnetic field generating device that provides a magnetic bearing capability;
integrating an foil bearing with the magnetic field generating device, wherein the foil bearing is integrated into the magnetic field generating device coaxially and concentrically about an axis or rotation of the shaft journal, leaving an air gap between the shaft journal and an outermost surface of the foil bearing; and
structuring and arranging the magnetic field generating device and the foil bearing to provide high force densities concurrently to support said shaft journal.
